(19) United States
(12) Patent Application Publication
(10) Pub. No.: US 2023/0341129 A1
(43) Pub. Date: Oct. 26, 2023

(54) UTENSIL PROFILE DETERMINATION SYSTEM

(71) Applicant: ELECTROLUX HOME PRODUCTS INC., Charlotte, NC (US)

(72) Inventors: John W. TAYLOR, Charlotte, NC (US); Sabari GOPALAKRISHNAN, Springfield, TN (US)

(21) Appl. No.: 18/028,048

(22) PCT Filed: Dec. 18, 2020
(86) PCT No.: PCT/US2020/065836

§ 371 Date: Mar. 23, 2023

Related U.S. Application Data
(60) Provisional application No. 63/088,052, filed on Oct. 6, 2020.

(51) Int. Cl. F24C 7/08; G01S 7/4865

(52) U.S. Cl. CPC F24C 7/082; G01S 7/4865; G01S 2205/02

(57) ABSTRACT

A utensil profile determination system and method for determining a profile of a utensil used for cooking liquids and foodstuff on a heating element of a cooktop surface are disclosed. Particular distances are determined and considered in forming the profiles, the distances relating to a cooktop surface, heating element, utensil and sensor. The utensil profile may include whether the utensil is present or absent, vertical movement and direction of the vertical movement, and Dry Pot. Certain remedial measures may be implemented as a result of particular utensil profile determinations.

### BACKGROUND OF THE INVENTION

The present disclosure relates to a system and method for determining a utensil profile, movement or condition (hereinafter profile) based upon detecting measurements of particular distances related to the utensil, the measurements being detected or made by a contactless remote sensor. The utensil may be used for cooking foodstuff on a heating element of an appliance cooktop surface. The remote sensor may be a time of flight (ToF) sensor. The present disclosure further relates to the initiation of remedial or prevention (hereinafter remedial) measures based upon the determined utensil profile. The remedial measures may include at least one of displaying an image, generating an alarm, affecting operation of an appliance cooktop surface and communicating a message. The utensil profile may include at least one of the utensil being present or absent, vertically moving along with direction thereof with respect to the sensor, and Dry Pot.

Cooking apparatus or cooktops are well known appliances for cooking foodstuff accommodated within liquid itself housed in a utensil. The cooktops may include cooktop surfaces having heating elements therein which are configured and arranged to generate heat for transfer to a utensil appropriately placed on the cooktop surface. The heating elements may use radiant, gas, induction and the like for generating the heat. The utensils generally used may comprise typical household appliances configured to accommodate the liquid therein. The appliances include cooktops, free standing ranges with cooktops on top, hoods, microwaves and the like as would be understood by the skilled person.

Heating of liquids in a utensil entails bringing the utensil atop the heating element, initiate heat generation and monitoring the liquid for the effects of heat thereon. Stopping the heating of liquids entails essentially the opposite operations. While the aforementioned is ubiquitous to most any kitchen, certain drawbacks remain including the requirement for the chef's attention to the liquid and heat generation. Were the chef to become distracted for any reason, the liquids may not cook as intended, the heat generation may not be properly initiated or ceased, and Dry Pot conditions may occur. A Dry Pot occurrence, as is known in the art, is having heat applied to an empty or near empty utensil, thereby creating self-evident hazardous conditions within the kitchen requiring remedial measures dependent upon when and how the hazardous situation becomes known to the chef. Accordingly, there is a need to determine a utensil profile based upon its location, direction of movement and level of liquid content to not only support the chef's operations but also help monitor and remediate hazardous conditions.

A number of solutions have been proposed in the art to affect the aforementioned. For example, Bach, in U.S. Pat. No. 9,109,805, proposes a range hood 115 including a number of temperature sensors 120, arranged in the range hood and positioned in either a one to one relationship to heating elements 105 on a cooktop surface 110 (see FIG. 1) or one to all single sensor 140 for an entirety of the cooktop surface (see FIG. 2). The temperature sensor may be used to detect the temperature of a heating element and/or of the cooktop surface in its entirety and/or that which is cooking on the heating element. Illumination warning devices 125 may be arranged to illuminate warning messages on particular dangerously hot heating elements (see FIG. 3) or generally on and for the surface itself (see FIG. 4). Bach is not concerned with utensil profile determination as such.

Kamei, in U.S. patent application Ser. No. 15/477,192, is directed to a cooking support system 100 that monitors cooking surface temperatures with the aid of: control device 110, processing unit 190, light emitter 191, camera 192 and overhead infrared sensor 193; all of which are positioned overhead from the cooktop 300. In operation, Kamei uses camera 192 to capture an image of a cooking surface including any cookware 400 that may be positioned thereon. The IR sensor is then used to detect a temperature of each cooking surface including any cookware atop the cooking surface. The temperature and location of temperature are fed to the processing unit which, in turn, is then used to recognize when portions of the cookware may be overheating. Upon detection of a dangerous condition, a warning to the cooktop operator is triggered via the light emitter emitting a particular warning light onto the cooktop. Kamei is not concerned with utensil profile determination as such.

Johnson, in U.S. patent application Ser. No. 14/924,900, is directed to a cooktop appliance 12 including a cooking surface 14 with heating elements 16 arranged to heat up cooking utensils 18. A cookware temperature sensor 28 and food sensor 30 associated with the cookware are further included whereby the food sensor is a probe which is physically positioned within the utensil 18 to physically engage foodstuff therein. Accordingly, the sensor determines the temperature of the food. As with the aforementioned references, Johnson focuses on dangerous situations which, as may be the case here, may result in burnt food. Accordingly, measurements of both the different temperatures of the food and the utensil are taken and compared with a threshold. Exceeding the threshold is understood to be a warning situation necessitating remedial measures such as reducing the heat being generated under the particular food and utensil. Johnson is not concerned with utensil profile determination as such.

### BRIEF SUMMARY OF THE INVENTION

Accordingly, embodiments of the present disclosure are provided to substantially obviate one or more of the problems arising out of the limitations and disadvantages of the related art in providing utensil profile, movement or condition (hereinafter profile) detection systems and solutions for cooking appliances used in the preparation of foodstuff, including providing: a time of flight (ToF) sensor with the appliance in the sensor's field of view, the ToF sensor configured to detect a distance between it and the appliance cooktop surface and/or heating element, utensil and surface level of liquid accommodated within the utensil; and a processor appropriately arranged and configured to determine the utensil profile based upon various measured distances and determinations therefrom. The utensil profile may include whether the utensil is present or absent, whether the utensil is in vertical motion and if so, the direction thereof, and whether a Dry Pot condition is present or eminently present. Other profiles may be included within the scope of this disclosure as envisioned by the skilled person.

Other embodiments include initiating remedial measures in response to particular detected profiles including safety switch off in response to a Dry Pot detection, initiating and ceasing heat generation at the heating element in response to the utensil profile of movement in the direction away from and towards the sensor respectively, and alarm generation including displaying of messages, generating audible alarms and communicating electronic messages. A digital light processor may be included to facilitate the displaying and a communication module may be included to enable communication between processor and appliance, which may be a smart appliance, and external communication devices. A contactless and remote temperature sensor may also be included to detect certain temperatures which may be included with various remedial measures. The sensors may be sensor arrays and operate in various spectrums including the visual and the infrared. The utensil profile determination system may further be applied across different cooking appliances and heat generation methods, such methods including but not limited to induction, radiance and gas. Such cooking appliances may include cooktops, free standing ranges with cooktops on top, hood, microwave ovens and the like.

### BRIEF DESCRIPTION OF THE SEVERAL VIEWS OF THE DRAWINGS

The accompanying drawings, which are incorporated in and constitute a part of this disclosure, illustrate exemplary embodiments and, together with the description, serve to explain the disclosed principals.

FIGS. 1A and 1B depict an overview of a utensil profile detection system environment according to embodiments of the present disclosure.

FIG. 1C depicts a time of a flight sensor as may be applied to liquid level detection.

FIG. 1D depicts an exploded view of a digital light processor.

FIG. 1E-IG depict a temperature sensor and an operation thereof.

FIG. 2A depict a utensil profile determination system mounted in a vent hood.

FIG. 2B depicts a utensil profile determination system mounted in a swing arm.

FIG. 3A depicts an exploded view of a utensil profile determination system.

FIG. 3B depicts an assembled view of the utensil profile determination system.

FIGS. 4A-4F depict applications of the utensil profile determination system.

FIG. 5 depicts a display generated by the utensil profile determination system.

FIGS. 6A-6C methods of operation of the utensil profile determination system.

### DETAILED DESCRIPTION OF THE INVENTION

The technology described herein finds application in utensil profile, movement or condition (hereinafter profile) determination with respect to a utensil configured for cooking on a heating element of a cooktop surface. The utensil generally includes a foodstuff accommodation portion and will be considered herein with respect to liquid accommodated therein. In operation, the utensil is brought proximate to the heating element thereby enabling a heat transfer from heating element to utensil to content of the utensil. When the utensil is removed from the heating element, as may be required upon completion of a cooking process, the heating element must be disengaged or deactivated. The utensil may include certain profiles indicative of the utensil's location and/or state of operation. For example, a utensil may be introduced on to the heating element thereby being physically present on the heating element or, if not introduced, physically absent from the heating element. The utensil may be raised from or lowered to the heating element. The utensil may further be introduced onto an active heating element with too little or no liquid, or arrive at such a state due to a cooking process or the like, thereby acquiring a Dry Pot status. Other profiles may be attributed to the utensil as envisioned by the skilled person.

In the event a particular profile is detected, an opportunity therefor arises to automatically introduced remedial measures. Such may include automatically activating the heating element upon the introduction of the utensil and conversely deactivating the heating element upon the utensil's departure. Additionally, in response to Dry Pot or eminent Dry Pot, the heating element may be disengaged, or safety switched off. Messages may further be communicated to the chef by way of displayed images on at least one of the cooktop surface, heating element, utensil and liquid. Audio alarms may be generated and/or communicated electronically. Still other remedial measures may be introduced as envisioned by the skilled person. Other embodiments of the present invention will become known from the following detailed description.

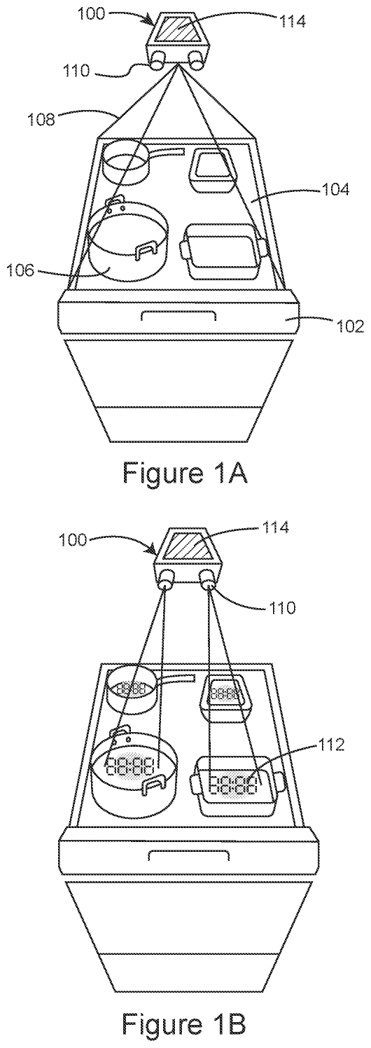

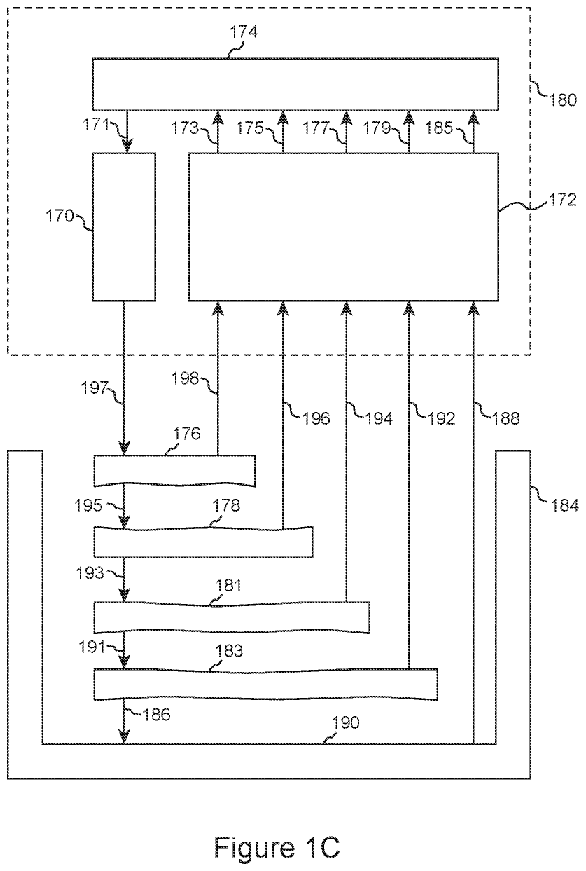

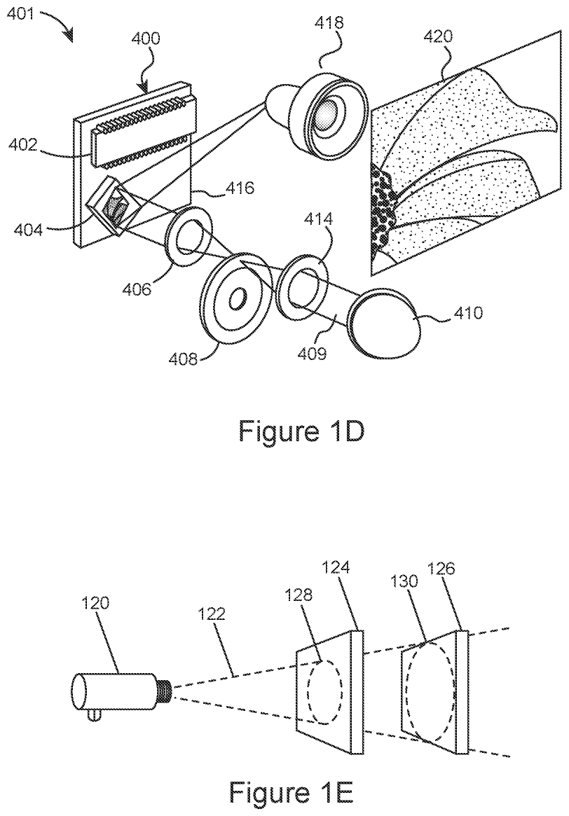

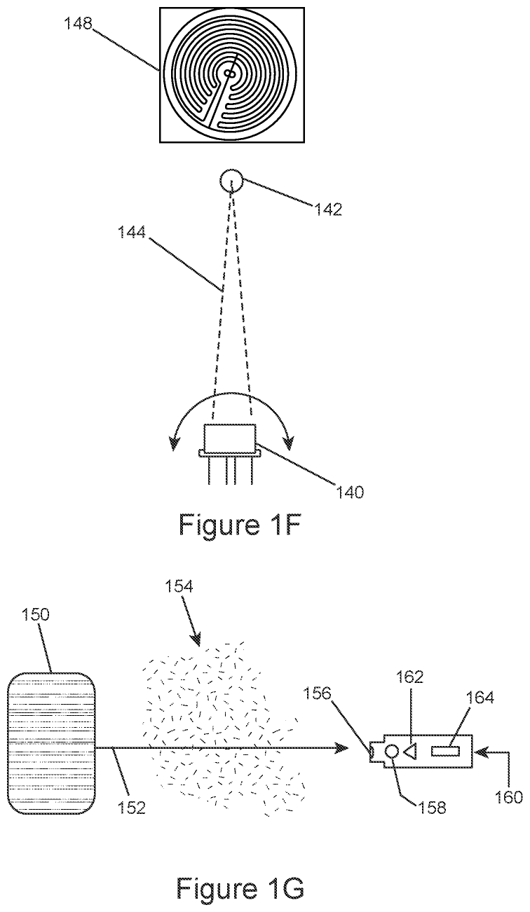

FIG. 1A depicts the present utensil profile determination system 100 including a sensor array 110 arranged above a cooktop surface 104 of cooktop 102 such that the cooktop surface falls within the sensor array field of view (108). Generic utensils 106 may be present on heating elements (not shown) of the cooktop surface 104. The sensor array includes at least one time of flight (ToF) sensor configured and arranged to detect certain distances with respect to itself and at least one of the cooktop surface 104, heating element (not shown), utensil 106 and liquid accommodated in the utensil (not shown). The ToF sensor may operate in the infrared or visible spectrum. The system 100 may include mounting elements 114 such as adhesive layers and magnetic elements. Other elements may be substitutes as envisioned by the skilled person. Accordingly, the system 100 may be mounted onto a vent hood or swing arm as well as within a microwave oven. Other features of the system not shown here include at least one: temperature sensor, digital light display (DLP), processor, communication module, alarm generator and the like as will be further detailed hereinbelow.

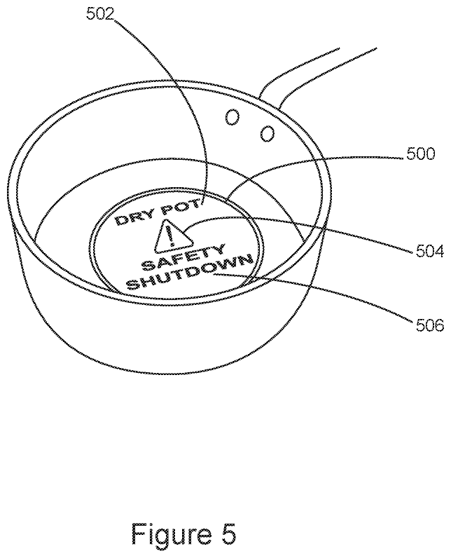

FIG. 1B depicts application of a DLP which may be used to depict images in the direction of cooktop 102, including on liquid in a utensil (112). An example image is depicted in FIG. 5. The images may include alpha-numeric characters, color, images and the like. The DLP may operate by laser, infrared and the like. The processor included in the present utensil profile determination system 100 may be optionally arranged on a single board computer and in electrical communication with at least one of the aforementioned ToF sensor(s), temperature sensor(s) and DLP. Examples of known single board computers include the Beagleboard series available from Texas Instruments and Raspberry P1 series available from the Raspberry PI Foundation. The processor may be arranged in communication with the cooktop and its controls in particular so as to affect heat generation as well as with each of the aforementioned elements or features which may be arranged on individual boards or a single board as envisioned by the skilled person so as to receive power and communicate with the processor. The cooktop 102 may be a smart cooktop, namely one that may receive automatically generated electronic instructions from the process and implement the instructions accordingly. The cooktop may comprise any such appliance including free standing range with cooktop on top, hood, microwave and the like. Heat generation may be affected by radiance, induction, gas and the like. Accordingly, the present disclosures have robust applications across numerous environments.

FIG. 1C depicts an operation of a typical ToF sensor with respect to detecting a distance to a level of liquid accommodated within a utensil. Other distance sensors may be substituted for the ToF sensor. Other applications include detecting a distance to other objects within the field of view including heating element and utensil. While individual detections may be made, successive detections may be assembled to provide an indication of a rate of change of a particular distance. As depicted, ToF sensor 180 includes transmitter 170 arranged to transmit a signal of known speed at and into utensil 184. The signal may comprise infrared or visible light. Where no liquid is present, the light is reflected by and from the utensil itself, the detection of which may offer a confirmation of the utensil's presence. The light may further reflect off of the surface of any liquid present in the utensil. As depicted, starting with where no liquid is present in the utensil, light incidence 186 is reflected 188 off the internal bottom 190 of the utensil. A lowest liquid level 183 would produce a first reflection 192 based upon a first incidence 191. Should the liquid level rise, for example to a next higher level 181, as may be the case with boiling, a second reflection 194 is produced from a second incidence 193. Likewise, third and fourth reflections (196, 198) may be produced by third and fourth incidences (195, 197) at next higher levels (178, 176). Similarly, where liquid initially starts from a higher level and evaporates, as may be the case from reducing, the aforementioned would run in the inverse. Functionally, the distance between ToF sensor and liquid level at any particular time may be determined by analyzing the time difference between the time of a particular emission, signal 171, and time of receipt of a particular reflection or return signal (173, 175, 177, 179, 188) to the sensor 180 after being reflected by the respective surface level of liquid (176, 178, 181, 183, 190). One such calculation entails multiplying the speed of the infrared light times the time of flight (to and from the liquid surface) and then divide the product by 2. Timer 174 may be employed to start during the exit of the light and run until the respective return reflection is detected. The processor may be appropriately configured and programmed to affect the aforementioned. Other such analysis may be affected by the skilled person without departing from the spirit of the present invention.

FIG. 1D sets out a functional depiction of a typical DLP, wherein the digital light processing element 401 comprises a DLP Chip Board 400 on which processor 402, digital micromirror device (DMD) 404 and memory 416 are suitably mounted and configured. Incident radiation 409 from source 410 is color filtered 408 and focused, via for example a shape lens 406, onto DMD 404 from which an image 420 may be generated and projected 418 onto a screen 412. The DLP may be of the compact, plug and play variety suitable for mobile projectors, appliances and the like. Its features may include an own chipset, such as the DLP200 (nHD), optical engine which may support up to 30 lumens, and an 8/16/24-bit RGB parallel video processor interface. The DLP may be board ready via an underside which includes pins arranged and configured to plug into an aforementioned single board computer and the like. As applied to the embodiments set out herein, the projected image may comprise select images, alphanumeric text and/or color and/or the like which is then selectively projected onto a screen of the cooktop surface, utensil, liquid and/or foodstuff, and the like.

FIGS. 1E-1G depict operations of a typical temperature sensor. Depending upon application, the area to be measured (i.e., the target) should at least fill the instrument's field of view if not largely overlap. For example, as depicted in FIG. 1E, temperature sensor 120 has a field of view 122 on a proximate target 124 and distal target 126: the targets being intended for temperature measurement. Accordingly, first and second measurement spots 128 and 130 are created on the proximate and distal objects 124 and 126 respectively. The second spot 130 being about equal to the target size represents a good arrangement for assessing an overall temperature of target 126. The first measurement spot 128, being smaller than target 124, represents a good arrangement for selectively assessing a temperature in and at a more specific location, namely, a center and lightened portion of target 124. In addition to the arrangement depicted in FIG. 1C, geometrical optics may be used to adjust (widen or focus) a measurement spot size and location as well as the field of view generally. Temperature sensors may also be pivotably mounted to physically adjust location of the field of view, measurement spot and the like as depicted in FIG. 1F. As depicted, temperature sensor 140 is configured for a narrow field of view 144 intended to focus on spot 142 of heating element 148. The example temperature sensor is a four-pin sensor which may include a reference tab RT along with clock line SCL, ground GND, supply voltage VDD and serial data signal SDA for connection and communication with the aforementioned processor via an I/O. Operation of a temperature sensor in a kitchen environment is depicted in FIG. 1G. As shown, cooktop surface 150 emits thermal radiation 152 to be collected and measured by temperature sensor 160 in a smoky and/or humid environment 154. Facilitating thermal radiation collection, the sensor 160 includes optics 156 arranged to focus incident radiation and correct for any potential environmental obstructions onto photosensitive detectors 158 which then convert the incoming thermal radiation into electrical signals via amplification 162 and electronics 164. Other temperature sensor arrangements, including for example use of thermopiles, may be applied here by way of design choice.

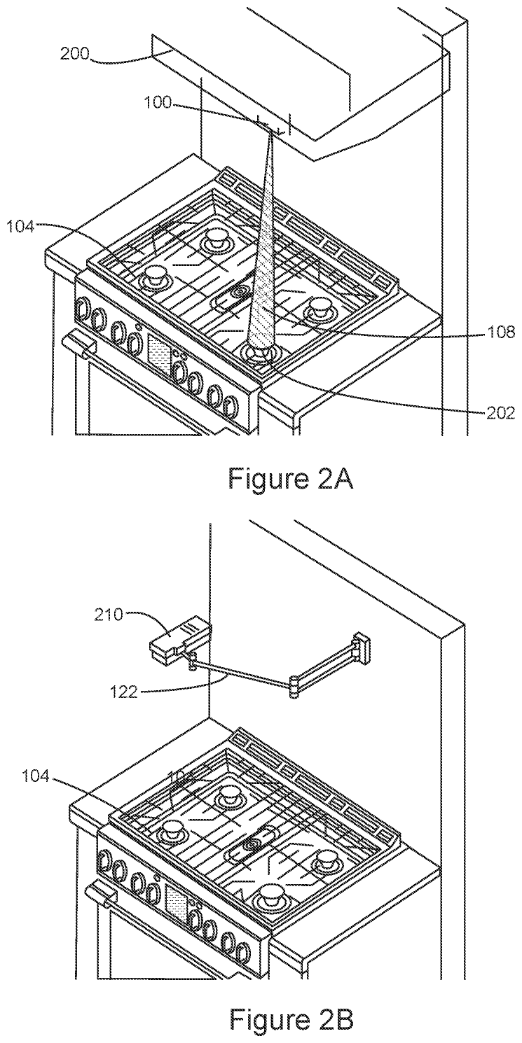

FIG. 2A depicts the utensil profile determination system 100 mounted on an underside of a vent hood 200 above and overlooking a cooktop surface 104. In this example arrangement, the sensors fields of view 108 are adjusted so as to train on heating element 202. FIG. 2B depicts the utensil profile determination system 100 mounted on a swing arm 210 so as to be selectively arranged above cooktop surface 104 with the surface 104 being within the sensors fields of view (not shown). Alternatively, the utensil profile determination system may be mounted under a floor of a microwave oven (not shown).

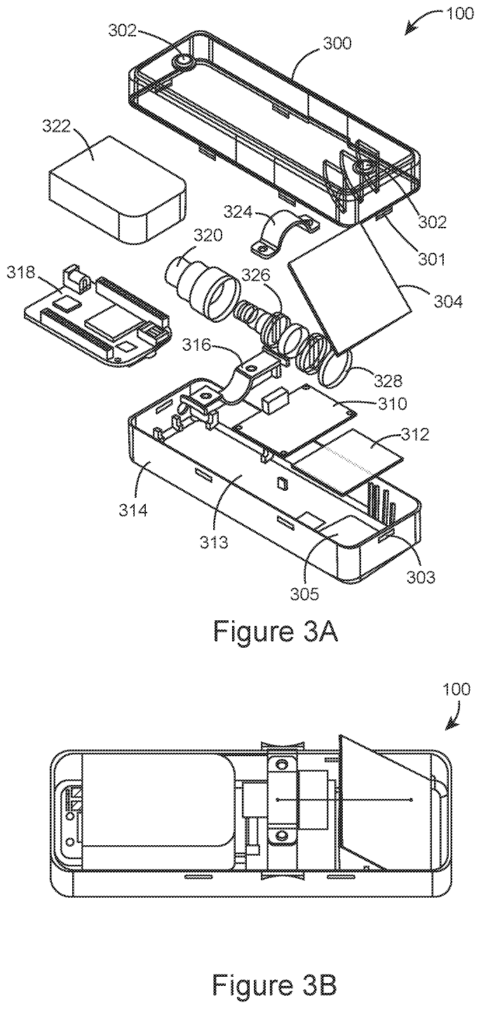

FIG. 3A depicts an exploded view of the present utensil determination system 100 according to certain embodiments of the present disclosure and FIG. 3B depicted an assembled view of a utensil profile determination system 100. System 100 includes a top housing 300 configured to mate with a base housing 314 by way of example clamps and clamp openings (301, 303) which may be arranged in a fixing relationship to mechanically fix the top housing 300 and base housing 314 together. Magnets 302 may be arranged on top of the top housing 300 for magnetically mounting the utensil profile determination system 100 as depicted, for example, in FIGS. 2A-2B. Other mounting elements may be applied. The order of the elements accommodated within the utensil profile determination system 100 are set out and described in an illustrative order. Board 318 may comprise the aforementioned single board computer arranged and configured to facilitate electrical communication with other elements housed within the utensil profile determination system 100 as well as with external devices by virtue of wireless communication. The communication may also be wired. A sensor board 310 is further arranged to be in electrical communication with board 318 facilitating, together with board 310, accommodation and operation of the aforementioned sensors, including the temperature sensor and time of flight sensor (not shown). As such, the sensors may be individually mounted on separate boards or collectively arranged on a single board. Board 318 may be arranged on a bottom 313 and within the confines of base housing 314, proximate to sensor board 310 and clear cover 312 which overlays opening 305 in the base housing. Optics holder 316 is arranged over sensor board 310, the optics holder 316 including accommodations for a lens holder 320 thereon. Within lens holder 320 are a number of optical elements including an optical lens 326 and a lock ring 328 locking the optical elements within the lens holder. Clamp 324 configured to overlay the lens holder 320 and mate with the optics holder 316 is arranged to hold the lens holder 320 in place while fixed to the optics holder 316. A mirror 304 is arranged proximate to the clear cover 312 at an angle, such as 45 degrees, such that radiation impinging thereon is reflected from the lens arrangement through the clear cover and out the opening 305 in the direction of the cooktop surface (not shown). A DLP, such as digital light processor display evaluation module 322 is arranged herein and configured to selectively project and display the image including real time cooking information below the utensil profile determination system with the processor, being in electrical communication with the DLP, generating the image and controlling the display location. The DLP may be further configured by the skilled person to generate free-form and on-demand displays. Other features may be included and/or substituted as would be understood by the skilled person. Forms and adhesive gaskets typically used for accommodating components in a housing are not shown for clarity purposes but would nonetheless be understood by the skilled person to be included and arranged within the utensil profile determination system 100.

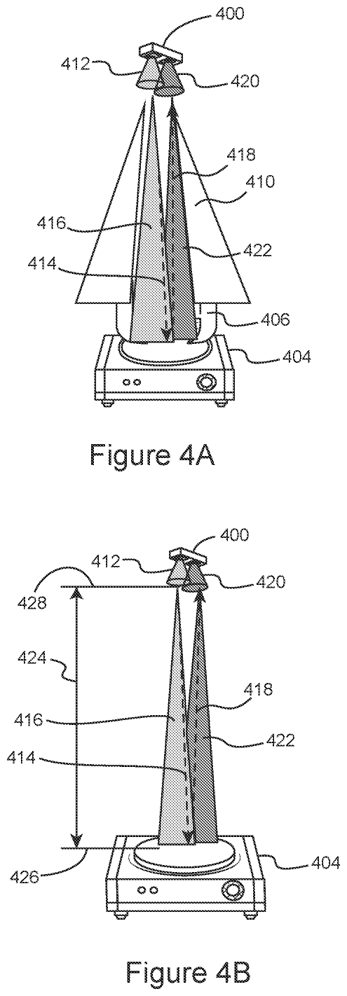

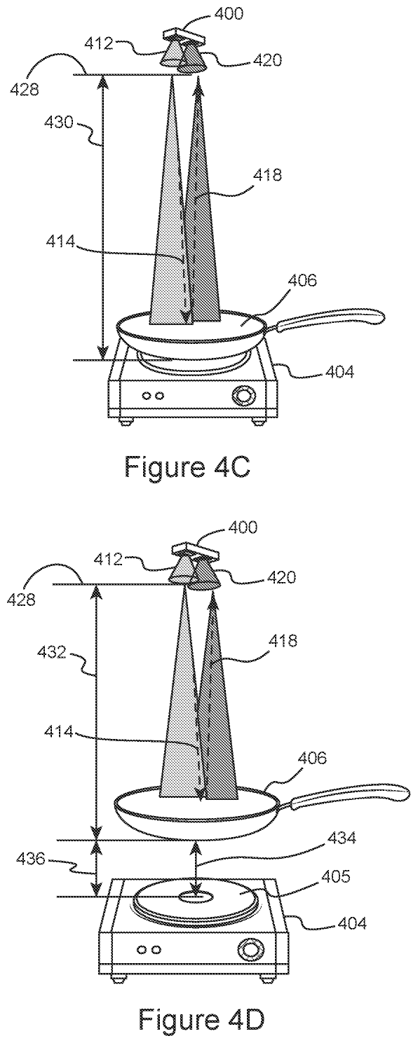

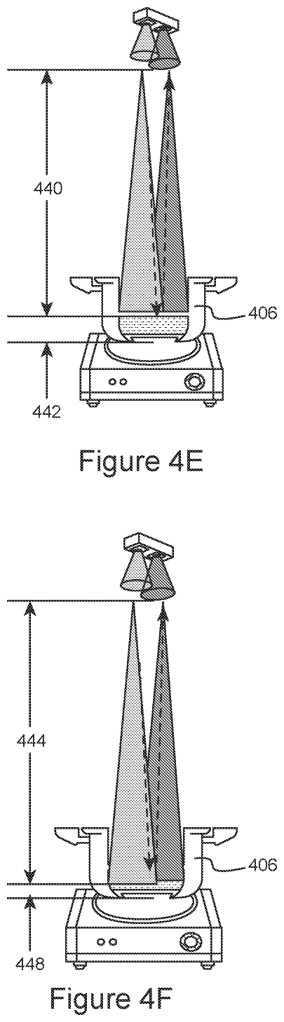

FIGS. 4A-4F depict a function of the present utensil profile determination system. Starting with FIG. 4A, sensor combination 400 is arranged above a representative cooktop surface 404. The sensors included within the combination may include the ToF sensor and the temperature sensor. Utensil 406 is positioned above the cooktop surface heating element 408 such that each of the sensors includes within its respective field of view the utensil, heating element and cooktop surface. As shown, the temperature sensor of the combination 400 has a first field of view 410 covering the entirety of the cooktop surface 404, utensil 406 and heating element 408. The ToF sensor of the combination 400 includes an emitter 412 for emitting light 414 in the ToF sensor emitter's field of view 416 which is then reflected 418 in the ToF receiver's (420) field of view 422 and detected at and by receiver 420.

FIGS. 4B and 4C depicts the determination of the utensil profile being “present” or “absent”. As depicted in FIG. 4B, the ToF sensor emitter 412 and receiver 420 are used to determine a first distance 424 between the ToF sensor (428) and the heating element 426 of the cooktop surface 404. The first distance 424 is determined by directing the emitting light 414 within the ToF sensors' first field of view 416 onto the heating element 426 so that the light may be reflected 418 within the TOF receiver's field of view 422 and detected at and by the receiver 420. As depicted in FIG. 4C, a second distance 430 between newly introduced utensil 406 and ToF sensor 428 is measured. The measurement is likewise made with incident light 416 from emitter 412 reflected (418) off the utensil 406 back up to receiver 420. As shown and as would be understood, the first distance is longer than the second distance. Accordingly, determining a difference between the measurements made during the situation as depicted in Figure B and a subsequent situation as depicted in Figure C reveals a change in the distance detected (first distance minus the second distance), the change indicative of the introduced utensil. In operation, the processor is configured to monitor for such differences and upon its detection assign the utensil profile of “present”. Where no difference or a positive difference is detected, the utensil profile of “absent” is assigned. Such monitoring may be made relatively continuously, repeating at a rate set by particular application.

FIG. 4D, in combination with FIGS. 4B and 4C, depict determination of another utensil profile, namely, “vertical movement” of the utensil with respect to the ToF sensor as well as the heating element as reference points. Alternatively, other reference points are available, including the cooktop surface, with the application of this present embodiments alternatively applied thereto. The “vertical movement” may further be characterized by its direction (434), namely “towards” the heating element 405 and “away” from the heating element 405; or “towards” the ToF sensor (412, 420) and “away from the ToF sensor (412, 420). Upon a determination of this utensil profile, certain remedial measures may be considered and/or automatically undertaken. Such remedial measures include activating the heating element in anticipation of the eminent arrival of the utensil as well as deactivating the heating element upon the confirmed departure of the utensil. Further, such activations may be gradual in proportion to the rate of the utensil's vertical movement. Still further remedial measures include displaying images, generating alarms and communicating messages.

FIG. 4D depicts vertical movement of the utensil. As shown, the vertical movement of the utensil is determined by taken the difference of the second distance 430 (between the utensil and the ToF sensor) from the first distance 424 (between the heating element and the ToF sensor) to arrive at a third distance 436. Changes in the third distance over time would be an indication of rate and direction of the vertical movement of the utensil. For example, where the third distance is determined to be getting larger with time, it may be determined that the utensil is moving towards the ToF sensor. Conversely, where the third distance is determined to be getting smaller with time, it may be determined that the utensil is descending towards the heating element. As the third distance approaches zero, so too does the utensil approach the heating element. Conversely, as the third distance approaches the first distance, so too does the utensil approach the ToF sensor. Accordingly, the rate of change of the third distance over time may also be calculated so as to determine a probable time of arrival at a particular point in space between heating element and sensor. The processor may be programmed to affect the aforementioned.

By way of automatic application of the aforementioned remedial measures, a distance threshold distance from the heating element is considered. Values for the threshold may be within a range of 5 mm to 100 mm. If the range of successive third distances with time start at a value greater than the threshold and then fall to within the threshold, it is determined that the utensil is approaching the heating element. The rate of descent may also be calculated to determine a time of arrival. Accordingly, the heating element may be activated such that the heating element heat generating operation is active at least upon the arrival of the utensil. Consideration of particular heating elements and their particular time requirements for arriving in an operation state may also be considered during the activation process. Conversely, if the range of successive third distances with time start at a value less than the threshold and exceed the threshold, it is determined that the utensil is no longer intended for the heating element and the heating element is accordingly deactivated. Likewise, the rate of ascent, based upon the change in third distance values over time may be calculated with the heating element deactivation proportionally matching the ascent such that at about the time the third distance exceeds the threshold, the heating element is fully deactivated. Hereto, consideration of particular speeds of certain heating elements may be factored into the calculation.

By way of alternative, the third distance may be calculated exclusive upon the relationship of successive second distances. Starting with a zero-point determination of the utensil resting upon the heating element (as depicted in FIG. 4C), the change in the second distances overtime are indicative of both the vertical movement and the direction of the vertical movement. Where the change in difference between successive second distances decreases, it is understood and determined that the utensil is moving in the direction of the ToF sensor. The rate of change of such successive second distance decreases would be indicative of the rate at which the utensil is moving in the direction towards the ToF sensor. Conversely, where the change in difference of successive distances increases, it is understood and determined that the utensil is approaching the heating element. With knowledge of the zero point and the rate of change of the differences over time, a determination of the estimated time of arrival of the utensil at the heating element may be calculated and the heating element activated accordingly in anticipation thereof. The converse may also be applied with the heating element deactivation coinciding with the departure of the utensil. Accordingly, the above threshold may be applied here as with the aforementioned. Namely, as the utensil is determined to enter a threshold defined distance from the heating element, the heating element may be automatically engaged by the processor and at a rate proportional to the rate of descent of the utensil. Conversely, as the utensil is determined to exit the threshold defined distance, the heating element may be disengaged and at a rate proportional to the ascent. Alternatively, to the zero-point determination being that of the utensil resting upon the heating element (430), the zero-point may be determined with respect to the heating element and the first distance (424). Further still, other points of reference may be employed including the cooktop surface as well as other points on the cooktop or elsewhere. Application of the aforementioned may be selected based upon cooktop surface type and/or heating element type.

FIG. 4E and FIG. 4F depict a determination of utensil profile being “Dry Pot”. As is known in the art, Dry Pot refers to a utensil with a minimal, if any, amount of liquid accommodated therein resting on a heat generating heating element. Such are known to be hazardous conditions to be avoided and/or remediated as required. With reference to FIG. 4E, in application, the first distance is measured followed by a fourth distance (440) representing the distance between a level of liquid in the utensil and the ToF sensor. A subtraction of the fourth distance from the first distance produces a difference (442) indicative of the level of liquid in the utensil along with a width of the utensil bottom. Taking such measurements over time, the rate of descent (decrease in the fourth distance) or ascent (increase in the fourth distance) of the liquid level over time may be determined. A second threshold indicative of liquid level associated with Dry Pot may then be considered so as to determine if and when the liquid level descends below the second threshold thereby prompting a utensil profile of Dry Pot. By way of example, such second threshold may be 5 to 8 millimeters. Other ranges and values may be applied as necessitated by at least one of the particular utensil, liquid and cooktop. Conversely, the rate of ascent may be considered with respect to a utensil liquid accommodation depth so as to determine if and when a boil over condition occurs, namely, the fourth distance is greater than the utensil accommodation depth. For example, and with reference to FIG. 4G, the fourth distance 444 is pictorially larger than the earlier measured fourth distance 442 as a result of the liquid level 448 decreasing within the utensil 406. In anticipation of such an occurrence, a remedial measure by way of alert to the chef and/or reduction of heat generation may be affected by the processor. Additionally, when the liquid depth is equal to or less than the threshold, the processor may affect the aforementioned remedial measures. The alert may include at least one of a written or pictorial indication of dry pot, an indication of the temperature of the liquid or dry utensil as may be determined by the temperature sensor, and an indication of what, if any, remedial measures were affected. Returning to the profile, here, the utensil profile would be “Dry Pot” when the aforementioned Dry Pot conditions are met or “Eminently Dry Pot” when about to be met.

FIG. 5 depicts an example visual alert 500 regarding the presence of a Dry Pot. As depicted Dry Pot is written out in easy to read letters (502), a warning symbol 504 is included for ease of understanding and visual recognition, and the remedial step affected is also written out in easy to read letters 506. The depicted message includes a red background and the warning symbol includes a yellow background. Other visual representations may be affected as would be known to the skilled person. Likewise, other alert forms may be implemented including audio alerts, electronic messaging, and the like.

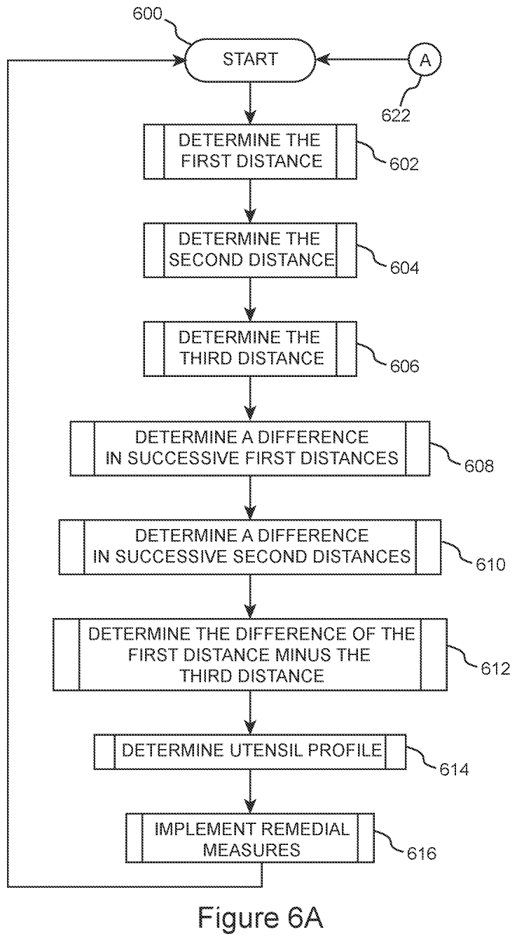

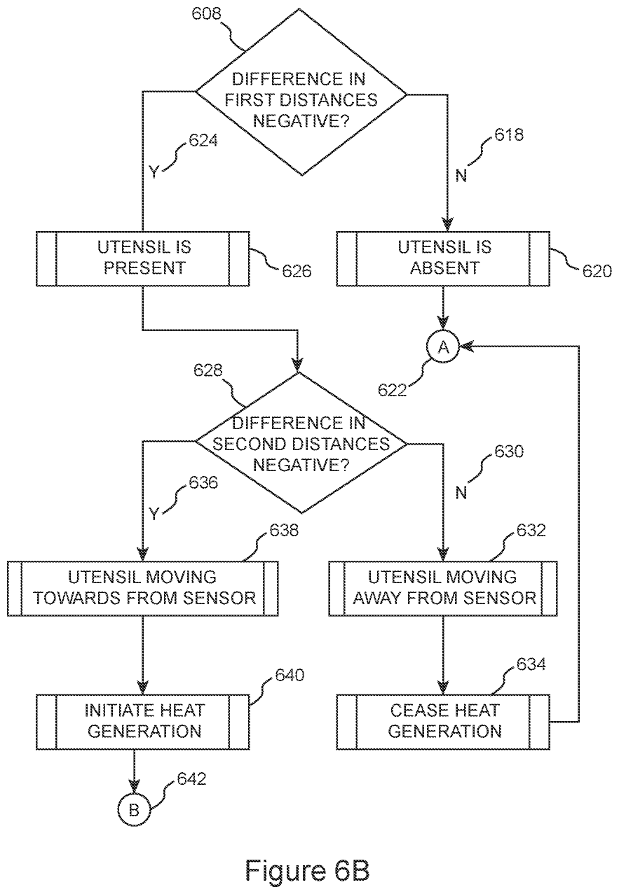

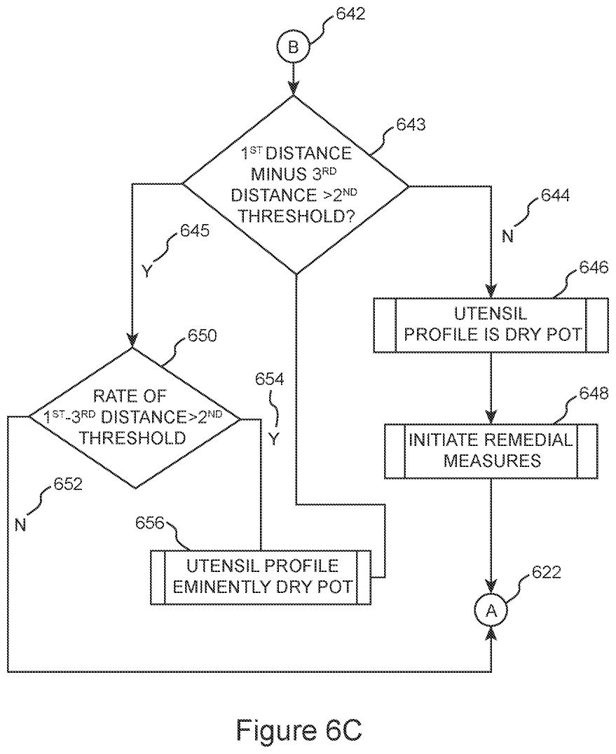

A method of determining a utility profile is set out in FIGS. 6A-6C. The method starts (600) and proceed with a determination (602) of a first distance is made, the first distance being between the cooktop surface and/or heating element and the ToF sensor. A determination (604) of a second distance is made, the second distance being between utensil and the ToF sensor. A determination (606) of a third distance is made, the third distance being between a surface of liquid within the utensil and the ToF sensor. A determination (608) of the difference in successive first distances is made, the determination as will be detailed in FIG. 6B being indicative of a utensil profile comprising one of utensil present or utensil absent. A determination (610) of the difference in successive second distances is made, the determination also detailed in FIG. 6B being indicated of a utensil profile comprising the utensil movement and direction thereof. Where no differences are detected and the overall first distance is approximately equal to a utensil absent profile then no utensil profile is determined (not shown). A determination (612) of the difference of the first distance less the third distance is made, the determination detailed in FIG. 6C being indicative of a Dry Pot utensil profile. Eminent Dry Pot utensil profile determination comprises the Dry Pot utensil profile determination with a timing element added thereto. A determination (614) of the utensil profile is made followed by implementation (616) of remedial measures (if any) followed still be the method returning to start (600).

FIG. 6B depicts method step 608 in detail starting with the determination (609) of whether the difference in successive first distances is negative. As shown, if the difference in successive first distances is not negative (618), a determination of a utensil being absent (620) is made and assigned as the utensil profile and the method returns to start 600 via connector A (622). If the difference in successive first distances is negative (624), a determination of a utensil being present is made (626) and assigned as the utensil profile and the method continues to query 628 which is a first step of method step 610. In query 628, a determination is made whether differences in successive second distances are negative. If the determination is negative (630), a determination that the utensil is moving away from the sensor is made (632) followed by a remedial step of ceasing heat generation (634) by the heating element and the method returns to start via connector A (622). If the determination of query 628 is positive (636), a determination that the utensil is moving towards the sensor is made (638) followed by a remedial step of engaging heat generation (640) by the heating element. The initiation and cessation may be made gradual by inclusion of timing elements with rate determinations with respect to the ascent and descent along with, optionally, consideration of the heating generating speed of the heating element. The method continues via connector B (642) to FIG. 6C which depicts method step 612 in detail.

In FIG. 6C, a difference of the third distance less the first distance (643) is made and compared with a second threshold indicative of a level of liquid under which Dry Pot conditions are met. If the difference is not greater than the threshold (644), a utensil profile of Dry Pot is determined (646) followed by the initiation of remedial measures (648) which include cessation of heat generation by the heating element and alert generation. The method then returns to start 600 via connector A (622). If the determination of query 642 is positive (645), a next query 650 of whether the rate of the difference of the third distance less the first distance is greater than a second threshold indicative of the liquid level eminently arriving at the first threshold. If the determination to query 650 is negative (652), the method returns to start 600 via connector A (622). If the determination to query 650 is positive (654), a utensil profile of eminent Dry Pot is made (656), and the method returns to query 642 for determination of the current liquid level with respect to the first threshold.

The communication functionality of the present embodiments may comprise network and communication chips, namely, semiconductor integrated circuits that use a variety of technologies and support different types of serial and wireless technologies as envisioned by the skilled person. The processor functionality of the present embodiments may be disposed in communication with one or more memory devices, such as a RAM or a ROM, via a storage interface. The storage interface may connect to memory devices including, without limitation, memory drives, removable disc drives, etc., employing connection protocols such as serial advanced technology attachment, integrated drive electronics, IEEE-1394, universal serial bus, fiber channel, small computer systems interface, etc. The memory drives may further include a drum, magnetic disc drive, magneto-optical drive, optical drive, redundant array of independent discs, solid-state memory devices, solid-state drives, etc. The memory devices may store a collection of program or database components, including, without limitation, an operating system, a user interface application, a user/application data (e.g., any data variables or data records discussed in this disclosure), etc.

It will be appreciated that, for clarity purposes, the above description has described embodiments of the technology described herein with reference to different functional units and processors. However, it will be apparent that any suitable distribution of functionality between different functional units may be used without detracting from the technology described herein. Hence, references to specific functional units are only to be seen as references to suitable means for providing the described functionality, rather than indicative of a strict logical or physical structure or organization.

The specification has described systems and methods for improving use of cooktops arising from attention to safety and foodstuff preparation by way of display and communication of real time cooking information. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments.

It is intended that the disclosure and examples be considered as exemplary only, with a true scope of disclosed embodiments being indicated by the following claims.

1. A utensil profile determination system for determining a profile of a utensil configured to accommodate and cook a liquid on a heating element of an appliance cooktop surface, the system comprising:
a time of flight sensor arranged with the appliance within the time of flight sensor's field of view, the time of flight sensor configured to detect and communicate a message comprising: a first distance between the sensor and at least one of the heating element and the appliance cooktop; a second distance between the sensor and the utensil; and a third distance between the sensor and a level of the liquid; and
a processor arranged in communication with the time of flight sensor to receive the message, the processor configured to determine the utensil profile, the utensil profile comprising at least one of: present or absent based upon a difference between successive first distances: vertical movement based upon a difference between successive second distances; and Dry Pot based upon a subtraction of the third distance from the first distance.

2. The utensil profile determination system according to claim 1, wherein:
the processor is further configured to determine whether or not the difference between successive first distances is negative; and
wherein the utensil profile is present when the difference between successive first distances is negative; and
wherein the utensil profile is absent when the difference between successive first distances not negative.

3. The utensil profile determination system according to claim 1, wherein:
the processor is further configured to determine whether or not the difference between successive second distances is negative; and
wherein the utensil profile vertical movement is in a direction towards the sensor when the difference between successive second distances is negative; and
wherein the utensil profile vertical movement is in a direction away from the sensor when the difference between successive second distances is not negative.

4. The utensil profile determination system according to claim 1, wherein:
the processor is further configured to determine whether or not the difference of the first distance from the third distance is greater than a first threshold; and
wherein the utensil profile is Dry Pot when the difference of the first distance from the third distance is not greater than the first threshold.

5. The utensil profile determination system according to claim 4, wherein:
the processor is further configured to determine, when the difference of the first distance from the third distance is greater than a first threshold, whether a rate of difference of the first distance from the third difference is greater than a second threshold; and
wherein the utensil profile is Eminently Dry Pot when the rate of difference of the first distance from the third distance is greater than the second threshold.

6. The utensil profile determination system according to claim 1, further comprising:
a communication module in communication with the processor, the communication module configured to enable at least one of wired and wireless communication between the processor and at least one of the appliance and an external communication device; and
a digital light processor positioned above the cooktop and configured to display an image on at least one of the appliance, the utensil and an interior of the utensil.

7. The utensil profile determination system according to claim 6, wherein:
the processor is further configured to initiate remedial measures, the remedial measures comprising at least one of displaying an image, generating an alarm and affecting of heat generation at the heating element;
wherein the image comprises at least one of alpha-numeric character, image and color;
wherein the alarm comprises at least one of an audio alarm, a visual alarm and an electronically communicable alarm; and
wherein the affecting of heat generation at the heating element comprises instruction to the appliance cooktop, via the communication module, to initiate, reduce or cease heat generation at the heating element.

8. The utensil profile determination system according to claim 7, further comprising:
a contactless temperature sensor in communication with the processor and arranged with the appliance within the temperature sensor's field of view, the temperature sensor configured to generate a second output comprising a temperature of the liquid; and
wherein at least one of the image and the alarm further comprise a temperature of at least one of the liquid, the utensil, the heating element and the cooktop surface.

9. The utensil profile determination system according to claim 1, further comprising:
mounting elements configured to mount the utensil profile determination system within a microwave oven or above the appliance within at least one of a vent hood and a swing arm; and
wherein the mounting elements comprise at least one of a magnetic element and an adhesive element.

10. A method for determining a utensil profile, the utensil configured to accommodate and cook a liquid on a heating element of an appliance cooktop surface, the method comprising the steps of:
determining with a time of flight sensor a first distance between the cooktop surface and the sensor, a second distance between the utensil and the sensor, and a third distance between a liquid level and the sensor; and
determining with a processor in communication with the flight sensor a difference in successive first distances, a difference in successive second distances, a difference of the first distance subtracted from the third distance, and the utensil profile based upon the difference in successive first distances, the difference in successive second distances and the difference of the first distance subtracted from the third distance.

11. The method according to claim 10, further comprising the steps of initiating remedial measures, the remedial measures comprising at least one of displaying an image, generating an alarm and affecting of heat generation at the heating element

12. The method according to claim 11, wherein the utensil profile comprises at least one of:
present or absent based the difference in successive first distances:
vertical movement based upon the difference in successive second distances; and
Dry Pot based upon the difference of the first distance subtracted from the third distance.

13. The method according to claim 12, wherein the step of determining the presence or absence further comprises the steps of determining with the processor whether or not the difference in successive first distances is negative, wherein the utensil profile is present when the difference in successive first distances is negative and wherein the utensil profile is absent when the difference in successive first distances is not negative.

14. The method according to claim 12, wherein the step of determining the vertical movement further comprises the steps of determining with the processor whether or not the difference in successive second distances is negative, wherein the utensil profile vertical movement is in a direction towards the sensor when the difference in successive second distances is negative and wherein the utensil profile vertical movement is in a direction away from the sensor when the difference in successive second distances is not negative.

15. The method according to claim 14, further comprising the steps:
initiating heat generation at the heating element as the utensil is moving away from the sensor; and
ceasing heat generation at the heating element as the utensil is moving towards the sensor.

16. The method according to claim 12, wherein the step of determining the Dry Pot further comprises the steps of determining whether or not the difference of the first distance from the third distance is greater than a first threshold, wherein the utensil profile is Dry Pot when the difference of the first distance from the third distance is not greater than the first threshold.

17. The method according to claim 16, further comprising the steps of determining, when the difference of the first distance from the third distance is greater than a first threshold, whether a rate of difference of the first distance from the third difference is greater than a second threshold, wherein the utensil profile is Eminently Dry Pot when the rate of difference of the first distance from the third distance is greater than the second threshold

18. The method according to claim 17, further comprising the steps of:
ceasing heat generation at the heating element; and
displaying the message on at least one of the appliance, the utensil and the liquid, the message comprising at least one of alphanumeric characters, images and colors.

19. The method according to claim 11, further comprising the steps of:
measuring with a contactless temperature sensor at least one of a temperature of the liquid, the utensil, the heating element and the cooktop surface; and
wherein at least one of the image and the alarm further comprise the temperature of at least one of the liquid, the utensil, the heating element and the cooktop surface.
